(19) United States
(12) Patent Application Publication
(10) Pub. No.: US 2013/0221010 A1
(43) Pub. Date: Aug. 29, 2013

(54) TANK ASSEMBLY, RELATED METHOD OF MANUFACTURE AND REINFORCEMENT METHOD

(71) Applicants: Darrell J. Sanders, Mason, OH (US); Robert R. Pinder, Chelsea (CA)

(72) Inventors: Darrell J. Sanders, Mason, OH (US); Robert R. Pinder, Chelsea (CA)

(21) Appl. No.: 13/405,994

(22) Filed: Feb. 27, 2012

(51) Int. Cl. B65D 90/08; B65D 88/76; B29C 65/22

(52) U.S. Cl. 220/565; 156/272.2

(57) ABSTRACT

A tank assembly includes an elongated plastic tubular pipe structure and at least one end wall or internal bulkhead wall attached to the plastic tubular pipe structure. The end wall or internal bulkhead wall is a composite unit formed by a plastic sheet member sized to cover a cross-sectional area defined by the tubular pipe structure and a composite reinforcement strip bonded to the plastic sheet member. The composite reinforcement strip includes an elongated plastic base portion having a plurality of spaced apart ribs extending from a first side thereof and lengthwise therealong, each rib comprising an elongated metal reinforcement encased in plastic, the plastic base portion having a second side abutting against a surface of the plastic sheet member. Other structures can be reinforced using composite strips that are electrofusion welded to one or more walls of the structure.

### TECHNICAL FIELD

The present application relates to a tank assembly and method for producing the tank assembly, as well as a method for reinforcing other structures.

### BACKGROUND

Tanks of various types are well known. Production of tanks utilizing a tubular pipe for the body of the tank is also known. For example, International Application No. PCT/FI2003/000631 discloses waste water tanks produced utilizing a tubular pipe body formed by spirally winding a thermoplastic profile. One issue faced in the production of such tanks, particularly when the tank will be buried in use, is providing end wall structures of sufficient strength.

It would be desirable to provide a tank assembly structure and method that is both efficient and economical in terms of end wall configuration and installation.

### SUMMARY

In one aspect, a tank assembly includes an elongated plastic tubular pipe structure and at least one end wall or internal bulkhead wall attached to the plastic tubular pipe structure. The end wall or internal bulkhead wall is a composite unit formed by a plastic sheet member sized to cover a cross-sectional area defined by the tubular pipe structure and a composite reinforcement strip bonded to the plastic sheet member. The composite reinforcement strip includes an elongated plastic base portion having a plurality of spaced apart ribs extending from a first side thereof and lengthwise therealong, each rib comprising an elongated metal reinforcement encased in plastic, the plastic base portion having a second side abutting against a surface of the plastic sheet member.

In certain embodiments, the elongated tubular pipe structure may be an HDPE pipe, the plastic sheet member may be formed of HDPE material and the composite reinforcement strip may have HDPE material as the base portion and encasing the metal reinforcement of the ribs.

In certain embodiments, the base portion of the composite reinforcement strip is electrofusion welded to the plastic sheet member and/or the plastic sheet member is electrofusion welded to the tubular pipe structure.

In certain embodiments, the tubular pipe structure is a steel reinforced polyethylene pipe and the composite reinforcement strip is a steel reinforced polyethylene strip.

In certain embodiments, the plastic sheet member is a unitary plastic sheet and the composite reinforcement strip is one of a plurality of composite reinforcement strips bonded to the plastic sheet member.

In certain embodiments, the composite reinforcement strip(s) extend(s) vertically upward along the plastic sheet member such that each rib runs vertically.

In another aspect, a method of producing a tank assembly involves: utilizing an elongated plastic tubular pipe structure to form a main body of the tank assembly and attaching at least one end to the plastic tubular pipe structure. The end wall is a composite unit formed by a plastic sheet member sized to cover a cross-sectional area defined by the tubular pipe structure and a composite reinforcement strip bonded to the plastic sheet member. The composite reinforcement strip includes an elongated plastic base portion having a plurality of spaced apart ribs extending from a first side thereof and lengthwise therealong, each rib comprising an elongated metal reinforcement encased in plastic, the plastic base portion having a second side abutting against a surface of the plastic sheet member.

In certain embodiments, the method includes placing electrofusion cord in contact with both the plastic sheet member and the base portion of the composite reinforcement strip; and passing electrical current through the electrofusion cord to fusion weld plastic of the plastic sheet member to plastic of the base portion, thereby bonding the composite reinforcement strip to the plastic sheet member.

In certain embodiments of the method the tubular plastic pipe structure is formed of a helically wound composite reinforcement strip that is substantially the same as the helically wound composite reinforcement strip of the end wall.

In certain embodiments of the method the tubular plastic pipe structure comprises HDPE material, the plastic sheet member comprises HDPE material and the composite reinforcement strip comprises HDPE material.

In another aspect, a method of reinforcing a wall of a plastic structure involves the steps of: utilizing a reinforcing member comprising a composite reinforcement strip including an elongated plastic base portion having a plurality of spaced apart ribs extending from a first side thereof and lengthwise therealong, each rib comprising an elongated metal reinforcement encased in plastic, the plastic base portion having a second side opposite the first side; abutting the second side of the reinforcing member against a surface of the wall of plastic structure; and electrofusion welding the reinforcing member to the wall.

In one implementation of the immediately preceding method, the plastic structure is a plastic pipe and the abutting step involves (i) arranging the composite reinforcement strip to run parallel with a lengthwise axis of the plastic pipe or (ii) arranging the composite reinforcement strip such that it wraps about the plastic pipe.

In another implementation of the method the plastic structure is a tank and the wall extends generally upright from the bottom of the tank.

### BRIEF DESCRIPTION OE THE DRAWINGS

FIG. 1. is a partial exploded view of a tank assembly;

FIG. 2 shows the plastic sheet member and composite reinforcement strips of the end wall of FIG. 1 in profile prior to being bonded together;

FIG. 3 shows an enlarged cross-sectional profile of a strip section;

FIG. 4 shows a strip section with associated electrofusion cord that will be used to bond the strip section to the plastic sheet member;

FIG. 5 shows an assembled view of the tank assembly;

FIG. 6 shows an exemplary wall configuration that can be used either internally of the pipe structure or at the end of the pipe structure;

FIG. 7 is a perspective view of a pipe including reinforcement strips; and

FIG. 8 is a perspective view of an open-top tank with reinforced side walls.

### DETAILED DESCRIPTION

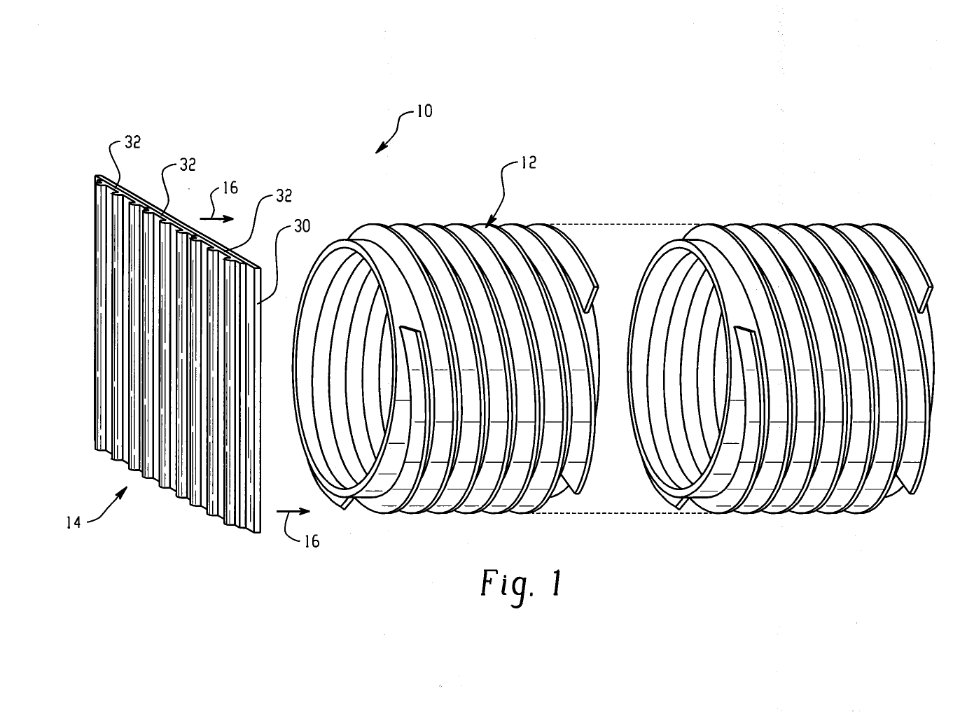

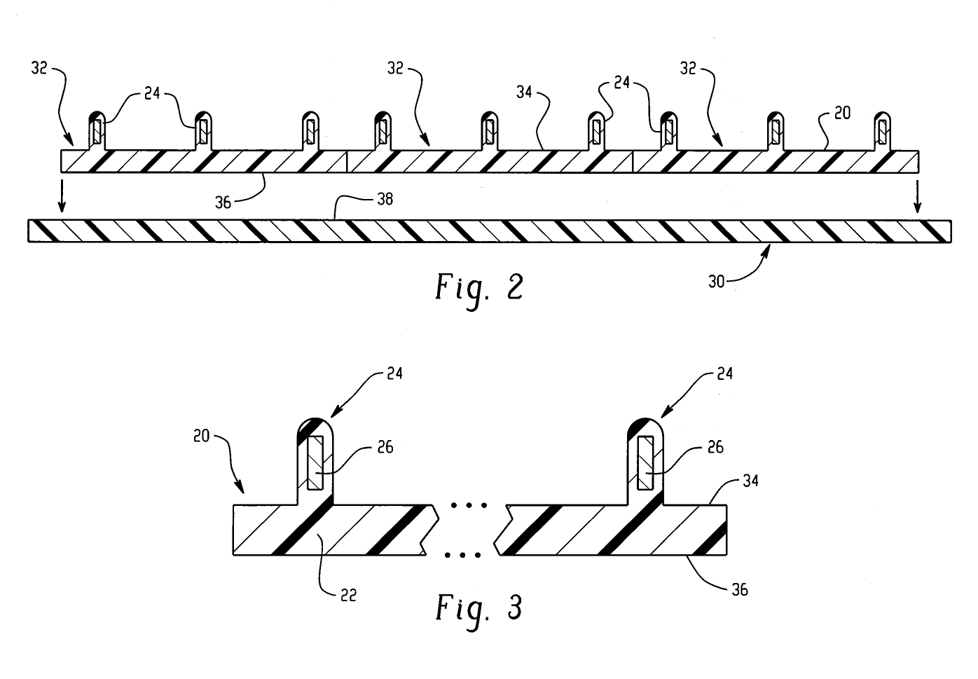

Referring to FIG. 1, an exploded partial view of a tank assembly 10 is shown. The tank assembly 10 includes an elongated plastic tubular pipe structure 12 and at least one end wall 14 that becomes attached to the plastic tubular pipe structure 12 as suggested by arrows 16. In the illustrated embodiment, the pipe structure 12 is a steel reinforced polyethylene pipe structure such as that shown and described in U.S. Pat. No. 7,004,202, which is formed by helically winding an elongated composite strip 20 (FIG. 3) that includes a plastic base portion 22 and a plurality of ribs 24 that include a metal reinforcement 26 encased in plastic. The exact number and size of the ribs could vary. Moreover, the tubular pipe structure 12 could be of other configurations, such as solid wall HDPE pipe, dual wall HDPE pipe, corrugated plastic pipe or pipe of other plastic materials. Although U.S. Pat. No. 7,004,202 and FIG. 3 focus on use a metal reinforcement that is in flat strip form, other types of metal reinforcement are possible, such as the wire-type metal reinforcement of U.S. Pat. No. 7,975,728, where inboard and outboard reinforcement members are provided in the rib. Another alternative would be use of reinforcement such as that shown in U.S. Patent Publication No. 2009/0117302 where, one example, the metal reinforcement has an inverted U-shape or V-shape with sidewardly extending feet encased within plastic that forms a hollow rib as opposed to a solid rib.

Regardless of the exact plastic pipe configuration, the end wall 14 is a composite unit formed by a plastic sheet member 30 sized to cover a cross-sectional area defined by the tubular pipe structure 12 and one or more composite reinforcement strip sections 32 bonded to the plastic sheet member 30. In the arrangement of FIG. 1 three strip sections 32 are used, but the number could vary. As mentioned above, each strip section could be a length of a strip of the type shown in FIG. 3, including elongated plastic base portion 22 having a plurality of spaced apart ribs 24 extending from a first side 34 of the base and lengthwise therealong, each rib having an elongated metal reinforcement 26 encased in plastic. A second side 36 of the plastic base portion abuts against a surface 38 of the plastic sheet member 30. Each strip section could also be of the configuration suggested above with reference to U.S. Pat. No. 7,975,728 or U.S. Patent Publication No. 2009/0117302.

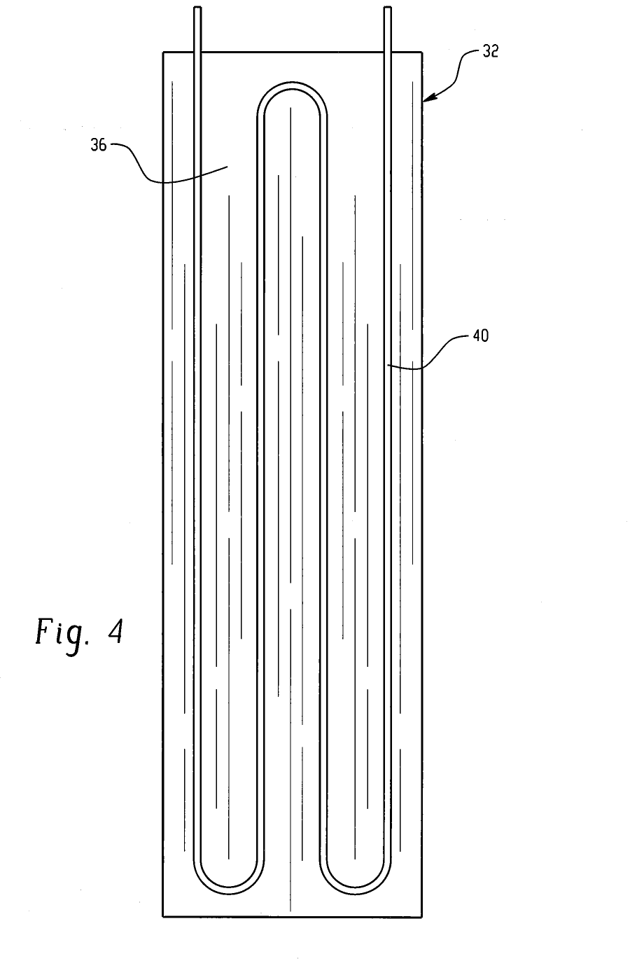

The strip sections 32 may be electrofusion welded to the sheet member 30. In this regard, referring to FIG. 4, a plan view of side 36 of a strip section with electrofusion chord 40 laid out thereon is shown. The electrofusion chord is sandwiched between the sheet and the strip section, and when the electrofusion chord is energized, the plastic of the strip section 32 becomes welded to the plastic of the sheet member 30.

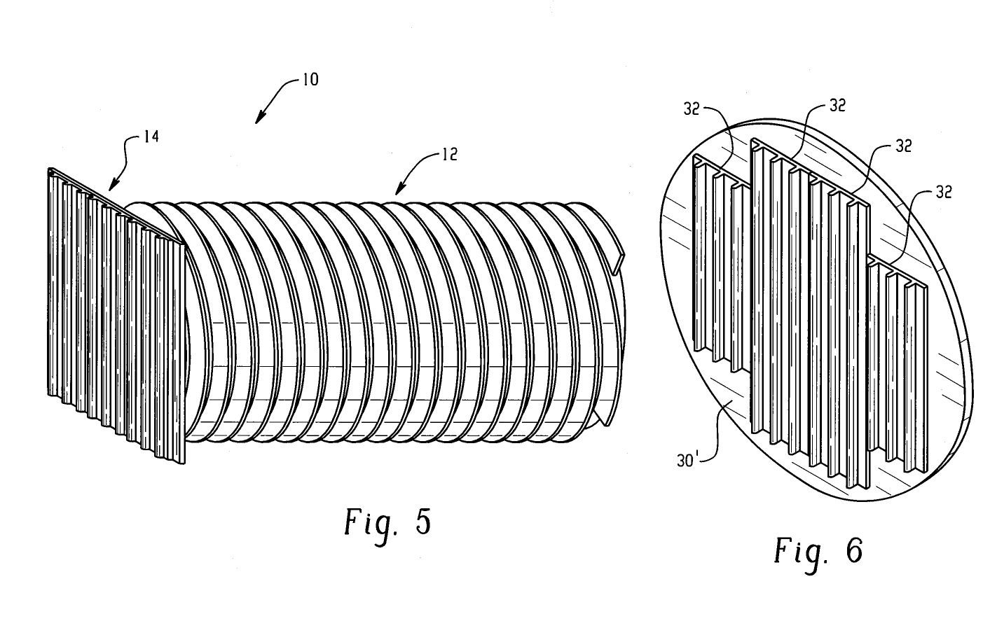

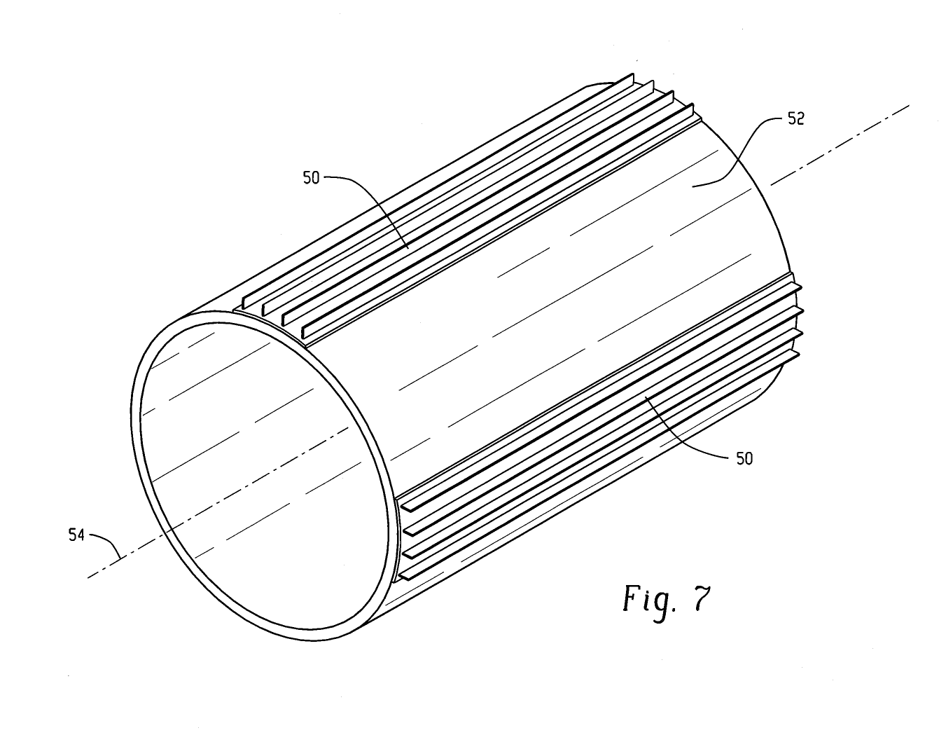

While the primary embodiment contemplates a rectangular sheet structure with strip sections to form the end wall of the tank (e.g., assembled form shown in FIG. 5), it is also contemplated that the composite wall structure could be used for internal walls of the tank (e.g., where a bulkhead wall is needed from some reason. In such an arrangement, the plastic sheet structure could be a circular (or other) configuration such as 30′ shown in FIG. 6 to match the circular (or other) cross-sectional configuration of the internal surface of the tubular pipe structure 12.

In the case of either the end wall or the internal wall, such wall can be connected to the tubular pipe structure using electrofusion welds or by other means, such as by extruding plastic material along the seam between the two parts.

The wall configuration used above provided a structurally reinforced wall that requires the use of less plastic than a simple plastic sheet to achieve similar structural strength, thereby reducing material cost.

While the illustrated tubular pipe is generally circular in end view, it is recognized that the tubular pipe could be of other configurations, such as elliptical or even rectangular. Moreover, electrofusion attached composite reinforcement strips could also be used for reinforcing other structures.

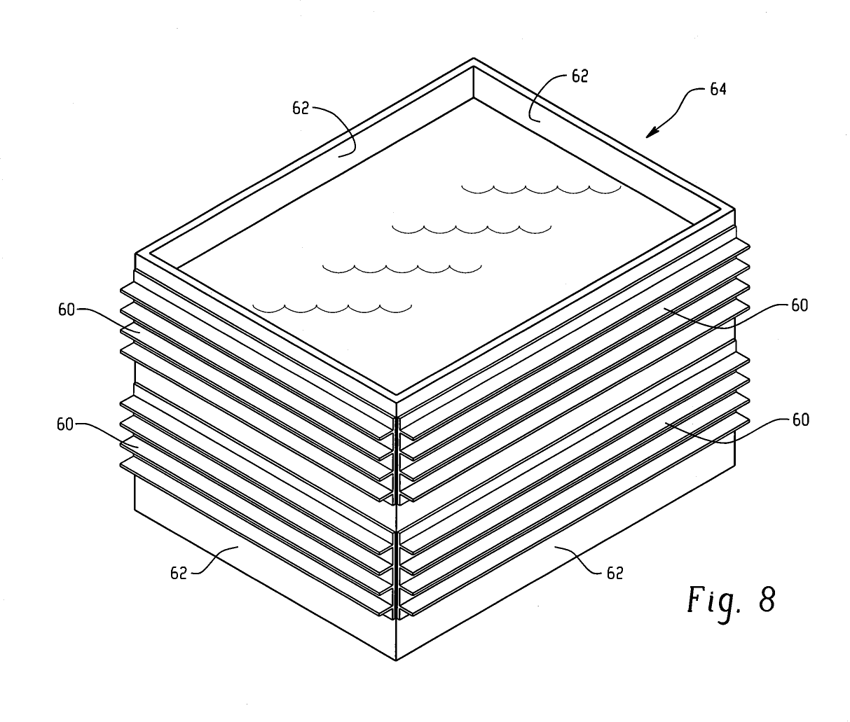

For example, as shown in FIG. 7 elongated reinforcements strip sections 50 could be electrofusion welded to the external surface of a solid wall HDPE pipe 52 for reinforcement. In the case of FIG. 7 the strips extend generally parallel to the lengthwise axis 54 of the pipe, but in other embodiments the strips 50 could be wrapped as rings about the pipe (e.g., generally perpendicular to the axis 54) or could be helically wrapped about the pipe.

Referring now to FIG. 8, in another example, reinforcement strip sections 60 could be electrofusion welded to the side walls 62 of tank 64 (e.g., with walls 62 made of HDPE sheet), In the illustrated embodiment, two horizontally oriented strip sections 60 are provided on each wall, but in other embodiments the strip could be oriented differently or more or less strips could be provided. In the case of a tank that is round in top view, the reinforcement strip sections 60 could be wrapped about the tank wall.

It is to be clearly understood that the above description is intended by way of illustration and example only and is not intended to be taken by way of limitation, and that changes and modifications are possible.

What is claimed is:

1. A tank assembly, comprising:
an elongated plastic tubular pipe structure;
at least one end wall or internal bulkhead wall attached to the plastic tubular pipe structure, the end wall or internal bulkhead wall comprising a composite unit formed by:
a plastic sheet member sized to cover a cross-sectional area defined by the tubular pipe structure;
a composite reinforcement strip bonded to the plastic sheet member, the composite reinforcement strip including an elongated plastic base portion having a plurality of spaced apart ribs extending from a first side thereof and lengthwise therealong, each rib comprising an elongated metal reinforcement encased in plastic, the plastic base portion having a second side abutting against a surface of the plastic sheet member.

2. The tank assembly of claim 1 wherein:
the elongated tubular pipe structure comprises an HDPE pipe;
the plastic sheet member is formed of HDPE material;
the composite reinforcement strip comprises HDPE material as the base portion and encasing the metal reinforcement of the ribs.

3. The tank assembly of claim 1 wherein:
the base portion of the composite reinforcement strip is electrofusion welded to the plastic sheet member.

4. The tank assembly of claim 3 wherein:
the plastic sheet member is electrofusion welded to the tubular pipe structure.

5. The tank assembly of claim 4 wherein
the elongated tubular pipe structure comprises an HDPE pipe;
the plastic sheet member is formed of HDPE material;
the composite reinforcement strip comprises HDPE material as the base portion and encasing the metal reinforcement of the ribs.

6. The tank assembly of claim 1 wherein the tubular pipe structure is a steel reinforced polyethylene pipe and the composite reinforcement strip is a steel reinforced polyethylene strip.

7. The tank assembly of claim 1 wherein:
the plastic sheet member is a unitary plastic sheet and the composite reinforcement strip is one of a plurality of composite reinforcement strips bonded to the plastic sheet member.

8. The tank assembly of claim 7 wherein:
each composite reinforcement strip extends vertically upward along the plastic sheet member such that each rib runs vertically.

9-15. (canceled)

16. A tank assembly, comprising:
an elongated tubular pipe structure formed by a steel reinforced polyethylene pipe;
at least one end wall attached to the tubular pipe structure, the end wall comprising a composite unit formed by:
a unitary plastic sheet member sized to cover a cross-sectional area defined by the tubular pipe structure;
a plurality of composite reinforcement strips bonded to the plastic sheet member, each composite reinforcement strip including an elongated plastic base portion having a plurality of spaced apart ribs extending from a first side thereof and lengthwise therealong, each rib comprising an elongated metal reinforcement encased in plastic, the plastic base portion having a second side electrofusion welded to a surface of the plastic sheet member;
wherein the plastic sheet member is electrofusion welded to the tubular pipe structure with an orientation such that each composite reinforcement strip extends vertically upward along the plastic sheet member with each rib running vertically along the end of the tubular pipe structure and each rib positioned at an exterior side of the tubular pipe structure.
